(19) United States
(12) Patent Application Publication
(10) Pub. No.: US 2009/0234513 A1
(43) Pub. Date: Sep. 17, 2009

(54) ELECTRONIC CONTROLLER

(75) Inventor: Steven John Wiggins, Wellington (NZ)

Correspondence Address: LEWIS, RICE & FINGERSH, LC;ATTN: BOX IP DEPT., 500 NORTH BROADWAY, SUITE 2000, ST LOUIS, MO, 63102, US

(73) Assignee: Hot Water Innovations Limited, Wellington (NZ)

(21) Appl. No.: 11/908,227

(22) PCT Filed: Mar. 10, 2006
(86) PCT No.: PCT/NZ2006/000040

§ 371 Date: Oct. 20, 2008

(30) Foreign Application Priority Data
Mar. 10, 2005 (NZ) 538737

(51) Int. Cl. G05D 23/00

(52) U.S. Cl. 700/300

(57) ABSTRACT

The present invention relates to an electronic controller and a computer-implemented method for a water storage system. The water storage system (10) has a storage tank (12) connected to a main energy source (24) and a main water source (14). The electronic controller (22) is provided with at least one sensor (32) to generate a sensor signal representing the state of the water in the storage tank (12). There is also an input device (38) for a user to input a command signal into the controller (22). A processor in the controller (22) receives the sensor signal, command signal, and source information relating to at least one of the main energy source (24) and main water source (14). Based on the source information and at least one of the sensor signal and the command signal, the processor controls one or more of the following aspects of the water storage system: the use of water from the main water source, the use of energy from the main energy source, the state of water in the tank, and the use of water from the tank.

### FIELD OF THE INVENTION

The present invention relates to an electronic controller for a water storage system, in particular but not limited to, an electronic controller for managing a hot water storage system.

### BACKGROUND TO THE INVENTION

Domestic water systems, in particular hot water systems, are known to offer little control over the quality of water delivery. For example, in some systems, altering the temperature of stored hot water systems requires the removal of an access cover and adjustment of the in-built thermostat. As for water volume, previous systems had fixed levels by design and these generally could not be altered. The pressure of water flowing out of the storage, also known as delivery pressure, could be permanently changed by fitting pressure relief valves but this required work by a skilled tradesperson.

More recently, water storage systems have employed electronic controllers to control parameters relating to the stored water.

U.S. Pat. No. 6,129,284 to Adams et al. relates to an electronic appliance controller particularly for gas-fired water heaters. The appliance has a main control unit, which includes a processor and a plurality of probes to determine, amongst others, water temperature. An input-output (I/O) unit is provided to accept inputs from a user and to display hot water information. The I/O unit may also be in communication with a remote processing system, such as a personal computer.

U.S. Pat. No. 4,869,427 to Kawamoto et al. relates to a shower system including a cold and hot water storage, a controller and a manipulator. The manipulator, shown as an input unit having buttons and a display, may be used to alter water pressure and/or temperature that is discharged at the showerhead.

It is an object of the present invention to provide an improved electronic controller for a water storage system or at least to provide the public with a useful choice.

### SUMMARY OF THE INVENTION

In one aspect, the present invention broadly consists in an electronic controller for a water storage system, the water storage system having a storage tank in communication with a main energy source and a main water source, the electronic controller comprising:
at least one sensor to generate a sensor signal representing the level of water or the temperature of water in the storage tank;
an input device for a user to input a command signal into the controller; and
a processor adapted to receive the sensor signal and command signal, and adapted to receive source information relating to at least one of the main energy source and main water source,
wherein the processor is adapted to control one or more of the following aspects of the water storage system based on the source information and at least one of the sensor signal and the command signal: the use of water from the main water source, the use of energy from the main energy source, the level or temperature of water in the tank, and the use of water from the tank.

The source information is preferably the cost associated with the use of the energy and/or water from the respective sources. The information may also be the availability of energy and/or water, a rating of the energy efficiency or restrictions on the use of the energy and/or water. The restrictions could be time, duration or usage amount restrictions, for instance. The source information may be obtained, for instance, from an energy and/or water meter(s).

The processor is preferably adapted to diagnose the condition of one or more components in the water storage system based on the source information and at least one of the sensor signal and the command signal.

In one form, one or more further sensors are provided to supply the controller with sensor signals representing the condition of the water in the storage tank. Here, the further sensors may be chosen from the group comprising: pH sensors, conductivity sensors, dissolved oxygen sensors, lime sensors and potability-type sensors.

In another aspect, the present invention broadly consists in an electronic controller for a water storage system, the water storage system having a storage tank provided with a heating device in communication with a main energy source, the electronic controller comprising:
at least one sensor to generate a temperature signal representing the temperature of water in the tank;
an input device for a user to input a command signal into the controller; and
a processor adapted to receive the temperature signal and command signal, and information relating to the main energy source,
wherein the processor is adapted to controllably operate the heating device based on the information relating to the main energy source and at least one of the temperature signal and the command signal.

The information relating to the main energy source is preferably the cost associated with the use of the energy. The information may also be the availability of energy, a rating of the energy efficiency or restrictions on the use of the energy source. The restrictions could be time, duration or usage amount restrictions, for instance.

Preferably the storage tank is connectable to one or more alternative energy sources. Most preferably, the processor connects the storage tank to one or more of the alternative energy sources if energy from the main energy source is unavailable. The processor may also connect the storage tank to one or more of the alternative energy sources if the temperature signal or command signal is determined by the processor to require an alternative energy source. In this form, the processor is adapted to receive information relating to one or more of the alternative energy sources.

Preferably, the controller receives information relating to the cost associated with the use of energy from each of the energy sources and connects the tank to the most cost-effective energy source. The information may also relate to the availability of energy, a rating of energy efficiency and restriction(s) on the use of energy from the alternative energy sources.

The controller may have a data storage device to store the cost associated with the use of energy from each of the energy sources. Alternatively the controller may receive cost information from a source remote from the controller. For instance, the controller may be connected to the internet to download cost information from a website or online server.

The controller preferably is also adapted to receive information relating to the cost of the use of water. Depending on the request of the user, the controller may determine the time at which water is best used for cost efficiency.

Preferably, the controller monitors and maintains a record of water and/or energy usage by the storage tank. The controller may use this information to predict future water and/or energy requirements for the storage tank. In one embodiment, the water usage record may be used together with the information relating to the cost of energy to determine the most cost-effective energy source.

The controller preferably also optimises energy efficiency based on a user's command signal to select the most energy efficient source. In addition, the user may set a condition to the selection of the most energy efficient source to the effect that the most energy efficient source is selected as long as any resulting cost change is below a specific amount. The user may also set criteria regarding the availability and efficiency of the source.

In a further aspect, the present invention broadly consists in an electronic controller for a water storage system, the water storage system having a storage tank connected to a main water source remote from the tank, the electronic controller comprising:
at least one sensor to generate a level signal representing the level of water in the storage tank;
an input device for a user to input a command signal into the controller; and
a processor adapted to receive the level signal and command signal, and information relating to the main water source,
wherein the processor is adapted to control the level of water in the storage tank based on the information relating to the main water source and at least one of the level signal and command signal.

Preferably the storage tank is connectable to one or more alternative water sources. Most preferably, the processor connects the storage tank to one or more of the alternative water sources if water from the main water source is unavailable. The processor may also connect the storage tank to one or more of the alternative water sources if the level signal or command signal is determined by the processor to require an alternative water source. In this form, the processor is adapted to receive information relating to one or more of the alternative water sources.

Preferably, the controller receives information relating to the cost associated with the use of water from each of the water sources and connects the tank to the most cost-effective water source. The information may also relate to the availability of water, a rating of water efficiency and restriction(s) on the use of water from the alternative water sources.

The controller may have a data storage device to store the cost associated with the use of water from each of the water sources. Alternatively the controller may receive cost information from a source remote from the controller. For instance, the controller may be connected to the internet to download cost information from a website or online server.

Preferably the controller is adapted to calculate the volume of water in the tank based on a known tank volume and the level signal.

Preferably, the storage tank includes a heating device that is connected to a main energy source to heat the water in the tank. In this embodiment, the controller is programmed to estimate the duration in which the water will be heated to a desired temperature.

In another form, the controller maintains a record of water usage from the tank. In this form, the controller may estimate the duration of use remaining before the stored water runs out.

The controller may also manage the stored water in accordance with a user input. For instance, the user may specify for the water to be heated to a certain temperature as soon as possible. The controller in this case may feed the heating device the maximum amount of energy allowable to heat the water quickly and/or may reduce the amount of water in the storage tank so that only the amount of water that is required is heated.

The controller may also manage the water storage system for maximum efficiency by evaluating an ideal time to add unheated water into the hot water storage to prevent an overall decrease in temperature of the water storage when unheated water is added.

Preferably the communication between the controller and the source(s) one allows the source to control the use of water by the controller. For instance, an electricity provider may instruct the controller to reduce the amount of heating at times of peak usage. The communication may also allow the source to monitor the use of energy and/or water by the tank to estimate use for the future.

In a preferred embodiment the controller is adapted to communicate with other appliances or controllers external to the hot water storage system. For example the controller may communicate with a home automation system, either to deliver information relating to the hot water storage or to receive information relating to a user command. Here, a person may set the temperature or learn the quantity of water available using a home automation input unit, such as a keypad and display unit, a touch screen or the like.

The controller may, in another form, be part of a home automation system. That is, the controller may be used not only for the control of the water storage system but also for a broader range of home automation applications, such as to control the home burglar alarm.

The communication between the controller and the external appliance/controller is preferably via radio frequency or other wireless communication techniques such as Bluetooth®.

As an optional addition, the controller may be adapted to monitor the functions of the hot water storage system components. Diagnostic functions may be programmed into the controller and, if required, further sensors may be provided on the components to be monitored. The controller may also be able to track the use of installed components and advise when the components are in need of repair.

The controller is also preferably configured to manage aspects of the water storage system downstream of the storage tank. In one form, the controller may control the delivery water pressure at, for example, a tap or showerhead. Other example aspects that could be controlled downstream are the delivery water temperature and delivery water flow.

To perform such downstream management, the controller is provided with downstream sensors, for instance to measure the water pressure and/or flow and/or temperature at a showerhead. The controller would also receive as input the user's desired value for the water pressure and/or flow and/or temperature. Based on these inputs, the controller may be able to determine if any changes to the pressure and/or flow and/or temperature values are needed. If so, the controller controllably activates/deactivates devices such as a water pump, heating element and/or mixing valve so that the sensed temperature/pressure/flow is substantially the same as a value inputted by the user.

In a still further aspect, the present invention consists in a computer-implemented method of controlling water storage system, the water storage system having a storage tank provided with a heating device in communication with a main energy source remote from the tank, the method comprising the steps of:
sensing the water temperature in the tank;
receiving a user command from an input device;
determining information relating to the main energy source; and
controlling the heating device in the tank based on the information relating to the main energy source and at least one of the water temperature and the user command.

Preferably the step of determining information relating to the main energy source comprises retrieving cost information associated with the use of energy. Alternatively or additionally, this step may comprise retrieving the availability, energy efficiency or restrictions on the use of energy.

Preferably the method of the invention further comprises connecting the storage tank to an alternative energy source if energy from the main energy source is unavailable. The method may also comprise connecting the storage tank to an alternative energy source if the temperature signal or command signal is determined to require an alternative energy source. The method may include the step of receiving information relating to one or more alternative energy sources.

In a still further aspect, the present invention consists in a computer-implemented method of controlling water storage system, the water storage system having a storage tank connected to a main water source remote from the tank, the method comprising the steps of:
sensing the water level in the tank;
receiving a user command from an input device;
determining information relating to the main water source; and
controlling the level of water in the tank based on the information relating to the main water source and at least one of the water level and user command.

Preferably the step of determining information relating to the main water source comprises retrieving cost information associated with the use of water. Alternatively or additionally, this step may comprise retrieving the availability or restrictions on the use of water.

Preferably the method of the invention further comprises connecting the storage tank to an alternative water source if water from the main water source is unavailable. The method may comprise connecting the storage tank to an alternative water source if the level signal or command signal is determined to require an alternative water source. The method may include the step of receiving information relating to one or more alternative water sources.

The present invention may also be said broadly to consist in the parts, elements and features referred to or indicated in the specification, individually or collectively, and any or all combinations of any two or more said parts, elements or features, and where specific integers are mentioned herein which have known equivalents in the art to which this invention relates, such known equivalents are deemed to be incorporated herein as if individually set forth.

The term ‘comprising’ as used in this specification and claims means ‘consisting at least in part of’, that is to say when interpreting statements in this specification and claims which include that term, the features, prefaced by that term in each statement, all need to be present but other features can also be present.

### BRIEF DESCRIPTION OF THE DRAWINGS

Preferred forms of the present invention will now be described with reference to the accompanying figures in which:

FIG. 1 is a schematic of a water storage system incorporating the electronic controller;

FIG. 2 is a flow diagram of an example electronic controller process to determine the energy source to use to heat water in the storage tank; and

FIG. 3 is a flow diagram of an example electronic controller process to diagnose the water storage system.

### DETAILED DESCRIPTION OF THE PREFERRED FORMS

### 1.0 System Layout

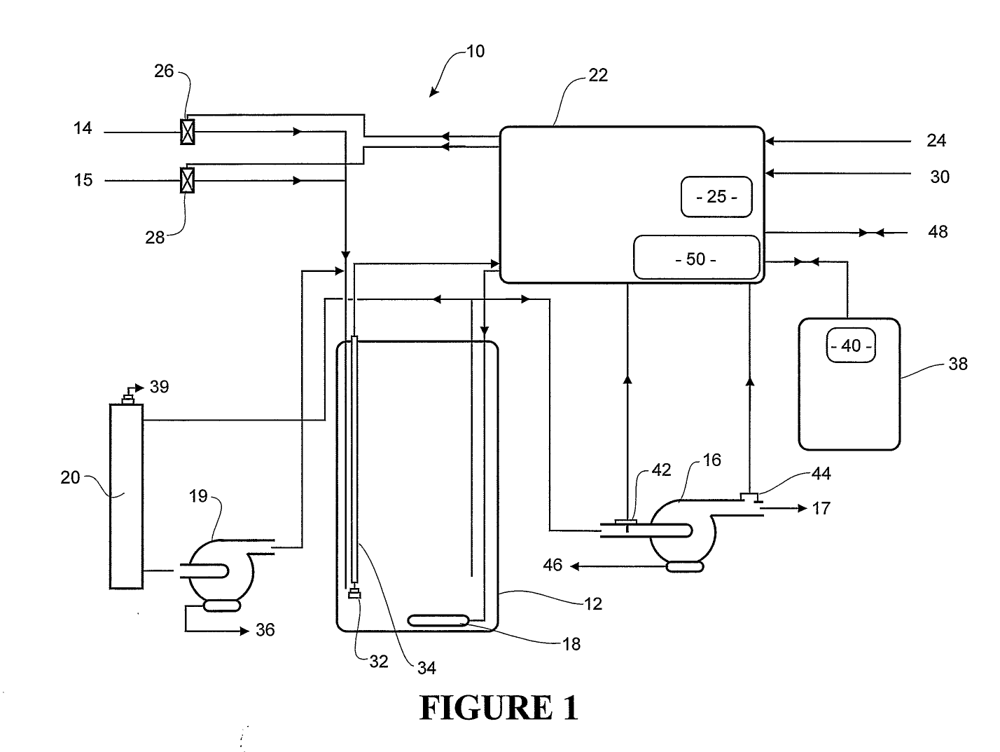

Referring to FIG. 1, the water storage system is shown generally as 10. In the example form hereinafter described, the water storage system 10 is a domestic water storage system. It is of course conceivable that the present invention can easily be adapted for use with other water storage systems, such as those used in industrial or commercial activities.

The water storage system 10 includes a water storage tank 12. The storage tank 12 may be a conventional cylindrical water tank or alternatively may include tanks of variable shape having a flexible liner to store water, as described in New Zealand Patent No. 244107. Although only a single storage tank 12 is shown, where required, a plurality of storage tanks may be used.

The storage tank 12 is in communication with a main water source 14 to receive water for storage. The main water source 14 may be a government-based council that supplies water to a certain region, or it may be a company in the private sector providing similar services.

The storage tank 12 may also receive water from an alternative source or sources, such as a rain water tank 15, which stores water harvested from rain. Other alternative water sources include greywater (water sourced from the kitchen, laundry and/or bathroom, but not the toilet), river water and well water.

To draw water from the storage tank 12 for use, a distribution pump 16 is most preferably employed. However, this is not essential as there are numerous other ways in which water can be drawn from the tank 12, for instance by having a gravity-fed system where the storage tank 12 is located such that water is drawn from the tank using gravity.

The outlet of the distribution pump 16, shown as arrow 17, carries water drawn from the tank 12 through water pipes to be used by the end-user. For instance, a user's showerhead or sink tap may be connected directly or indirectly to the pump outlet 17.

In the preferred form, the water storage system 10 is a hot water storage system. The storage tank 12 therefore includes a heating device(s) to heat the water stored in the tank. The preferred heating device is an immersed heating element 18 that heats the stored water when the element 18 is fed with electrical energy. Persons skilled in the art will be aware of other forms of heating devices to heat stored water, such as a gas heater or a boiler-type heater that could be used in replacement of or in addition to the heating element 18.

The water storage system may alternatively be a cold water storage system. The water may be stored in its ambient temperature, or may be actively cooled using a cooling device. One example cooling device is a refrigeration unit, commonly used in portable water coolers. The refrigeration unit utilises a compressor to compress a refrigerant that is sent down cooling coils. The coils, which may be immersed in the stored water, extract heat from the water in the tank to cool the stored water. Persons skilled in the art will be aware of other forms of cooling devices that may be used in replacement of or in addition to the refrigeration unit.

For brevity, the description herein focuses on the application of the water storage system as a hot water storage system. Skilled persons can easily adapt the teachings below to suit a cold water storage system. For instance, instead of using a temperature sensor and a heating element to heat stored water to a user desired temperature, the cold water storage system may use a temperature sensor and a refrigeration unit to cool water down to a specific temperature. Other aspects of the hot water storage system may be applicable to the cold water embodiment without necessitating adaptation, such as monitoring the quality of the cold water and/or subjecting the cold water to water tests and/or purification.

To power the components in the storage tank and/or water system, a main energy source is required. In the preferred form, the energy is electrical energy and is obtained through mains electricity source 24. The preferred electrical energy will power both controller 22 and the components of the storage tank and/or water system, such as heating element 18.

Alternative sources of energy to heat the water are also preferably provided. In the figure, a solar heater 20 is provided as an alternative heat energy source. The solar heater 20 may be a conventional solar panel used for the purposes of heating water, as is known in the art. In one form, the solar heater 20 may comprise layers of stainless steel between which water is made to flow. In use; the layers of stainless steel are heated under the sun and the heat absorbed from the sun is transferred to the water flowing through the layers. A pump 19 may be used to draw water from the main water supply 14 or storage tank 12, and to pass the drawn water through the solar heater 20 to heat the water.

Other forms of energy to heat the water can also be used, for instance a heat pump water heater. The process employed in heat pump water heaters is essentially the reverse of the cooling mechanism employed in refrigerators—while refrigerators extract heat from inside an enclosure and transfer that heat to an external area, heat pump water heaters extract heat from an external area and transfer that heat into a tank to heat water.

Another alternative source of heating energy is natural gas. Where employed, the storage tank 12 is provided with a typical burner assembly that connects to a main source of gas.

### 2.0 Electronic Controller

To manage the water storage system, an electronic controller 22 is provided. The controller 22 is provided with at least one processor to carry out required computations and control operations. An example suitable processor is the ATMEL AVR 8-bit microprocessor.

The controller also includes memory devices, which may be Random Access Memory (RAM) and/or Read Only Memory (ROM). The AMTEL microprocessor is preferred as it includes on-chip programmable Flash and Electrically Erasable Programmable Read-Only Memory (EEPROM). The programmable aspect of the controller memory allows in-situ reprogramming of the controller by a technician or installation of software upgrades, patches or changes.

The controller 22 should also be provided with components such as a Real Time Clock (RTC), an Analogue to Digital Converter (ADC) and input/output (I/O) circuitry. The RTC is used to keep track of time, which may be used to determine when certain controlling actions should be initiated. For instance, a user may wish for the controller to power-up the heating element daily from 11 pm to 1 am. The ADC is used to convert incoming analogue signals, such as from sensors, into digital signals that can be analysed by the processor. The I/O circuitry provides a signalling interface between the processor and external components, as will be described below. Where the AMTEL processor is used, there is no need to provide separate components as all of the above three components are embedded in the AMTEL processor.

There are preferably three main circuits in the controller—the interface circuit, control circuit and communication circuit. The interface circuit is designed to condition signals coming into the controller 22 from external components. For instance, the controller 22 may accept an input representing the water level sensed in the storage tank. In most cases, the input voltage may not be high enough to be processed by the processor. So, the interface circuit may amplify the input signal in this regard. Like in the AMTEL processor, which contains the appropriate interface or I/O circuitry, the interface circuit may be embedded in the controller. This in-built I/O circuitry is generally reconfigurable to match the type of input/output through manipulation using software.

The control circuit gives the processor the ability to control devices that run on mains electrical power. This is because the processor itself, which operates under relatively low current/voltage, is unable to power or operate components in the water storage system that require high current/voltage, such as the water pump 16 or heating element 18. So, in one form, the control circuit comprises triac switches. These switches can be instructed by the processor to enable/disable and vary the high current supplied to the required components.

To operate a device that runs on mains electrical power, the controller sets bits in the input/output (I/O) port of the processor connected to the control circuit for that device. This arrangement also allows the controller to read the status of the device by reading the bits on the I/O port of the processor. Such a feature will assist in the diagnostic aspects of the system, as will be described later in the specification.

The communication circuit conditions incoming input communication data into the controller. Such communication data may come from a keypad unit, which an end-user might utilise to input commands or feed desired values of certain control parameters into the controller. For instance, communication between a keypad unit and the processor may be made using the well-known RS232 communication link. This link requires voltages of +12V and −12V. However, processors commonly run on voltages of 0V and +5V. In such a case, the communication circuit functions to convert the RS232 voltage into the processor voltage and vice versa.

As the controller 22 operates using electrical energy, it is connected to the main electricity source 24. All other components in the water storage system preferably obtain electrical energy through the controller 22. In this way, the controller 22 is able to monitor and control all electrical energy use in the system. The amount of electrical energy used is preferably stored in the controller, as will be described later with reference to Table 1.

It is also conceivable that the controller 22 could be connected to a back-up or alternative electricity source, examples of which include a wind turbine, battery, a large capacitor or solar cell. This would ensure that, in the event of a mains power-out, the controller 22 will retain important data such as system memory and RTC. Depending on the nature of the back-up electricity source, the controller 22 may even be used for limited purposes.

As mentioned earlier, the controller 22 itself has internal memory components, such as Flash or EEPROM. In some cases, the capacity of the internal memory may not be sufficient, such as if the controller 22 stores historical records of water and/or energy use. For extra storage capacity, the controller 22 is ideally provided with a data storage device 25. This may be a hard disk type device or alternatively may be solid state memory.

The processor of the controller 22 is programmed as to the information that should be recorded and saved in the data storage device 25, for instance, the amount of water and/or energy used in a day. This saved data may be retrieved by the processor of the controller 22 to predict future requirements of water and/or energy. Data that is stored could be, in one form, in a database as follows:

TABLE 1
Energy/Water Use Database

| Day | Energy Use (kW) | Water Use (l) |
|---|---|---|
| 1 Jan. 2005 | 105 | 210 |
| 2 Jan. 2005 | 95 | 170 |
| . | . | . |
| . | . | . |
| . | . | . |

Based on the above data, the controller 22 may predict the energy use for 3 Jan. 2005 to be around 90-100 kW and the water use to be around 150-2001. If the controller 22 is allowed by the user to carry out operations based on such predictions, perhaps on an ‘Intelligent’ mode, the controller 22 may control the volume of water in the storage tank so that no more than 200l is stored. This will prevent energy wastage when the water is required to be heated.

Further, the controller 22 may predict the duration taken for a desired amount of water to be heated to be displayed to the user. As an example, a user may wish to raise the temperature of the water in the storage tank from 42° C. to 50° C. The controller 22 here will determine the amount of water in the tank and may use the equation below:

$$Heat \text{-} up time ( hours ) = \frac{\begin{matrix}Amount of Water ( Gallons ) \times \\ Temperature Rise ( ° F . )\end{matrix}}{375 \times Energy ( kW )}$$

The data storage device 25 may also store pricing information either retrieved from the sources of water and/or energy or as inputted into the controller 22 by the user. An example cost table is shown below:

TABLE 2
Energy/Water Cost Database

Energy (¢/kW)

| Day | Night | Water (¢/m³) |
|---|---|---|
| 19 | 14 | 1.50 |

The data storage device 25 may be regularly updated with pricing information, or may alternatively be updated in real-time. These can be achieved, for example, by connecting the controller 22 to the pricing source via a fixed connection. In one form, the pricing source is a website or information on an internet server and the connection is an online connection. The controller 22 may continuously monitor for any reduction or discount, or increase in pricing and suitably change in real-time or ‘on-the-fly’ the source that is used. Alternatively, the controller 22 may alert the user of the change in pricing and allow the user to choose whether the source should be changed.

The pricing information may also be used by the processor to optimise times and durations in which the water in the storage tank is heated, for instance. By way of example, if a user expresses no urgency for the water to be heated from 42° C. to 50° C., the controller 22 could defer the heating process until later at night when the charge for energy use per kW is lower than that during the day.

### 2.1 Holistic Operation

The preferred form controller 22 manages the water storage system 10 in a holistic manner, that is, the controller 22 has a ‘whole picture’ view of the system. To operate on a holistic level, the controller 22 retrieves information not only from the storage tank and the end-user, but also from the source of water and/or energy.

### 2.1.1 Water Source

To holistically manage the water in the storage tank, in one form, the controller is adapted to receive information relating to the main water source. The preferred types of information include the cost of using the water, the availability of water, restrictions on the use of the water and may extend to the quality of water from the source. There may also be a set efficiency rating, where an environmentally-friendly source such as rain water is given a higher rating than that from a mains water source.

In one embodiment, the information relating to the main water source is obtained from one or more water meters. In another embodiment, the controller may alternatively or additionally communicate with a valve 26 that controls the flow of water from the water source 14 to the storage tank 12. The valve is preferably a solenoid valve; however, other types of valves are also envisaged, such as electronically-controlled globe valves that are operated using actuators.

By monitoring the operation of the solenoid valve 26 and the water in the storage tank 12, the controller 22 is able to determine information relating to the flow of water from the source to the tank 12. That is, if the controller 22 senses that the solenoid valve 26 is open, but observes no rise in water level in the storage tank, the controller 22 may infer that there is no water available from that water source.

The controller 22 may also control the solenoid valve 26. The solenoid valve 26 can be energised/deenergised by the controller 22, which in turn controls the flow of water through the valve. The solenoid valve 26 may be controlled by the controller 22 through the use of a triac in the controller control circuit, preferably with zero-crossing switching.

If desired, the controller 22 may also communicate with a sensor located near the water source. The sensor may monitor the water source for availability, pressure and/or quality of water.

The controller 22 may receive water pricing information from the source of water 14, or a third party provider. It is envisaged that pricing information could be made available online. Alternatively, the pricing information may be inputted into the controller 22 by the end-user using an input device, as will be described in detail later.

Where an alternative water source is provided in the system 10, the controller 22 is also adapted to communicate with that source. Preferably, the controller is also able to control the flow of water from the alternative source to the tank. In one form, a solenoid valve is provided for each alternative source of water. In the figure, a solenoid valve 28 is connected to the source of rain water 15.

Preferably, information relating to the availability and cost of water from the alternative water source is also communicated to the controller 22. Further, one or more sensors to determine the quality and/or amount of the water from the alternative source are also provided so that information relating to the same can be relayed to the controller 22. The quality of the alternative water source, such as rainwater or greywater, may alternatively be determined by interfacing the controller 22 with a water test and/or purification system that is in communication with the alternative water source.

### 2.1.2 Energy Source

The water storage system may also operate holistically by adapting the controller 22 to receive information relating to the main energy source. Referring to FIG. 1, the controller 22 is connected to the electricity source 24 as previously described. The controller 22, in this preferred form, is able to monitor the cost, availability, efficiency rating and any restrictions on the use of electricity for the water storage system. In one embodiment, the controller monitors one or more energy meters to obtain information relating to the main energy source.

In addition, the controller 22 preferably also receives electricity pricing data through a price source 30. The price source 30 may be the electricity company acting as the electricity source 24, or alternatively, the price source 30 may be the end-user who inputs pricing data into the controller by means of a user input device. As previously described, the data relating to usage cost may be stored in the controller storage device 25 in the form of a database, as shown in Table 2.

Where one or more alternative energy sources are utilised, such as the previously described solar heater 20, the controller 22 is also adapted to receive information relating to that source. For this reason, the devices involved in the use of the alternative energy source are preferably monitored by the controller 22. With reference to FIG. 1, the solar heater may be in communication with the controller 22 via communication line 39. This communication may provide information relating to the temperature of or flow rate through the solar heater 20, for instance.

The communication between the source(s) and the controller 22 also enables authorised third-parties to control and/or retrieve information from the water storage system remotely. For instance, if an electricity shortage is imminent, the electricity company to which the controller 22 is connected may instruct the controller 22 to utilise less electricity, or may instruct the controller 22 to only use electricity at certain times of the day. Furthermore, the electricity company may keep a record of energy usage by its customers so it can more accurately predict the customers' requirements for energy in the future. In one form, the electricity company may have access to the usage data shown in Table 1.

### 2.1.3 Storage Tank

In addition to receiving input from and communicating with the sources, the controller 22 is also able to receive input from and communicate with components that work to deliver water from the water storage tank 12 to the end-user. For this, the controller includes one or more sensors to sense the state/condition of the water in the storage tank 12.

Ideally, a temperature sensor 32 and a level sensor 34 are provided. As will be expected, these sensors provide the controller 22 with information relating to the temperature of the stored water and the level of the water in the tank 12 respectively.

In the preferred embodiment, the temperature sensor 32 is a Dallas 1-Wire digital thermometer. In this form, when the controller 22 wishes to know the temperature of the water in the tank, it issues a read-instruction to the sensor 32. A correctly functioning sensor will return a binary number having bits representing the water temperature. The sensor 32 is programmed to return the binary number in a specified period, for instance within 0.5 seconds. If the temperature sensor 32 fails to do this, or if a binary number with fewer or more bits is returned, the controller 22 considers this data as invalid and assumes that the sensor 32 is faulty. This is used for diagnostic purposes, as will later be described.

There are a number of ways in which the water level may be sensed, such as an infra-red (IR) distance measuring device, magnetically-operated reed switches, a capacitive probe, a hydrostatic sensor or a tank pressure sensor.

In the preferred embodiment, a system of stainless steel probes is used as the level sensor. The probes protrude downwards into the tank from a plate on the top of the tank. The probes are of varying lengths, the longest extending almost to the base of the tank, and the shortest extending only a few centimeters below the top. As the water level rises, it makes contact with each of these probes in turn, allowing the controller to progressively sense the water level.

This arrangement allows the controller to detect a fault or invalid data from the level sensor. In particular, if a fault, such as a single probe becoming disconnected or damaged, occurs, the controller will sense an unusual combination of probe signals. If such a combination is impossible where the probe and tank are functioning normally, the controller will consider this data invalid, and assume that a fault has occurred.

A similar diagnostic feature can be enabled for the capacitive probe sensor. When the capacitive probe is functioning normally, the voltage returned from the sensor (which represents the level of the water) should fall within specified limits. Voltages outside these limits are invalid, and indicate that the capacitive probe is not working correctly.

The water level may also be determined using a tank pressure sensor. As the water level in the tank increases, the water pressure measured at the bottom of the tank increases. By calibrating the increase in water pressure with the water level, the tank pressure sensor can reliably work as a level indicator. As with the previous sensor embodiments, the operation of the sensor can be monitored since the controller is able to detect, by way of an invalid return signal, an abnormal operation of the sensor.

Other sensors may also be provided if necessary, such as one or more pH sensors, conductivity sensors, dissolved oxygen (DO) sensors, lime sensors and any other potability-type sensors including optical-based contaminant sensors.

### 2.1.4 End-User

To complete the holistic operation of the controller 22, the controller 22 is adapted to receive inputs from a user through a user input device, such as a keypad 38. The keypad 38 ideally includes a display unit 40 which could be used to display to the user parameters being monitored by the controller 22. The display unit 40 may be an LED display bar graph, an LCD, a cold cathode plasma, or hot fluorescent alphanumeric display. The user input device may alternatively be a touch screen device or the user's home computer.

In the most preferred embodiment, the keypad 38 and display unit 40 are wall-mountable. The display unit 40 is adapted to show the state of the water in the storage tank, such as the water temperature and water level. It could also show the output of the Real Time Clock (RTC), the status of the heating element (on/off) and status of the source valves (on/off). Diagnostic messages as will later be described could also be displayed.

As described briefly above, the user may input pricing information relating to the use of energy and/or water in the water storage system. This can be achieved using the preferred form input device, keypad 38. Alternatively, the user may connect a computing device, such as a laptop or Personal Digital Assistant (PDA), to the controller 22. This would allow the user to more easily input large amounts of or complicated data into the controller 22. The connection and communication between the controller 22 and the computing device is described in greater detail in the ‘Home Automation’ section of the present specification.

Further, the user may input desired values relating to certain parameters of the water in the storage system. Example parameters include temperature, pressure and flow rate of the water. A user may instruct the controller 22, by inputting desired values into the keypad 38, to match the parameters of the water sensed by the controller 22 with the user desired values. This control operation is well-known in the art of controlled water heating and can be easily implemented using devices and systems available in the current market.

Further, the user may input instructions into the controller 22 to replace the present source of energy and/or water with an alternative source of energy and/or water, or vice versa. For instance, the user may wish to use all available water from the rain water storage 15 before using water from the mains supply 14 for environmental and/or cost purposes.

In the most preferred embodiment, the user may enable/disable predefined modes in the controller 22. For example, one mode could be ‘Efficiency’, where water in the tank is only heated at night when the cost associated with heating the water is lower. Additionally, water drawn from the tank during the day is not replaced until just prior to the heating cycle, so as not to reduce the overall temperature of the stored water during the day. This may be set as a default mode of the controller 22.

Another mode could be a ‘Holiday’ mode, in which a user may set the controller 22 to ‘sleep’ for a specified period. In this mode, the controller 22 will allow the water temperature to drop, and only reheats the stored water a day before the specified period elapses. The delay of one day may alternatively be configurable, so the user may set the controller 22 to only heat the water hours before the specified period elapses.

### 2.1.5 Extended Holistic Operation

The holistic operation of the controller 22 may be extended to monitor and control downstream aspects of the water storage system. For instance, the controller 22 may be able to control the temperature, pressure or flow of water that is received by the user.

Sensors are preferably provided downstream of the storage tank 12, such as a temperature sensor (not shown), flow sensor 42 and pressure sensor 44. Information from the sensors are sent to the controller 22, which may then be compared to the user desired values for temperature, pressure or flow as inputted by a user using keypad 38. Based on this comparison, the controller 22 may communicate with the pump 16 via a communication line 46 to alter the pressure or flow of the water, or the controller 22 may communicate with the heating device 18 in the storage tank to suitably alter the temperature of the stored water.

The controller 22 may also obtain information from the flow sensor 42 to determine how much water has been used in any one day. The volume of water used can easily be determined by multiplying the flow rate of water by the duration of flow. This data could be stored in the controller storage device 25 in a database shown in Table 1.

One particular benefit of extending the controller's holistic operation is the ability to overcome the pressure drop that occurs in a water outlet when more outlets are opened. For example, if a user is having a shower and another user in the same household turns a tap on, the user in the shower will immediately notice a drop in shower water pressure. The controller 22 in this case may learn of the drop in pressure through pressure sensor 44 and/or similar sensors downstream of the tank 12 and react appropriately by instructing the pump 16 to increase the pump output water pressure or flow.

### 3.0 Home Automation

The controller 22 may also be connected to a home automation unit 48. As is known in the art, home automation units provide an integrated control solution to operate home equipment such as lighting, security and climate-control devices. The home devices to be automated are connectable to one or more user interface devices, such as a touch screen, or keypad-and-display unit. Recent developments in this area have led to the use of wireless devices to control the home automation unit, such as wireless-enabled Personal Digital Assistants (PDAs), home computers and even internet-enabled televisions and mobile telephones.

In one form, the controller 22 is connected to the home automation unit such that the user is able to input desired values or commands into the controller 22 using the input device of the home automation unit. This avoids the need for a separate keypad 38 for the controller 22.

In another form, the controller 22 may form part of the home automation unit in that it is able to control home equipment other than the water storage system. For instance, the controller 22 may be adapted to control the central heating unit in the home to ensure the temperature inside the home is maintained at a desired temperature.

The communication lines between the controller 22 and the devices in the water storage system are provided, in one form, using industry-standard wired connections. Alternatively, the controller 22 may be provided with a wireless communication module 50 so that the communications lines can be made wireless. The wireless module 50 may be based on Bluetooth®, wireless LAN or 802.11/WiFi technology, for example. By having such a wireless communication, the user input device or keypad 38, may be implemented using a user's internet/Bluetooth-enabled mobile telephone. Alternatively, the user may connect a PDA or laptop to the internet and the network provided in the home using wireless LAN or WiFi so that the user may communicate with the controller 22 remotely.

### 4.0 Diagnostic Operation

The controller 22 may be adapted to monitor the functions and workings of the water storage system components. Diagnostic functions may be programmed into the controller and, if required, further sensors may be provided on the components to be monitored. If the controller 22 finds a component being monitored to have unusual readings, the controller may display a warning to the user.

Preferably, the diagnostic results are displayed on the display unit 40. Where the display unit is a simple LED display, there may not be sufficient display room to display the entirety of the diagnostic result. Thus, in cases where a fault is determined, the controller 22 may display a diagnostic/fault code, which the user could reference against a user manual. Alternatively or additionally, the controller 22 may request the user to contact a service number so that a technician may attend to the fault. An example display for this may be ‘Error Code 10: Please contact technical support on 04-123 4567’.

Example forms of monitoring will now be described. These are only exemplary and persons skilled in the art will be aware of the various other ways in which and/or parameters with which monitoring may be done.

### 4.1 Heating Element Triac Failure

This diagnostic capability is achieved by monitoring the stored water temperature once the controller 22 signals the heating element 18 to turn off. In an element triac failure, such as an internal short circuit, the water will continue to be heated despite the controller's instruction.

Therefore, if the heating element 18 has been instructed to turn off, but water temperature remains high or increases, the controller 22 can signal an element triac fault.

### 4.2 Water Solenoid Failure

Here, the controller 22 senses a rise in stored water level even though the controller 22 has signalled the water source valve 26/28 to shut. This suggests that either the triac controlling the water valve has short circuited, or that the valve itself is stuck open. Ideally, the controller 22 should cycle the water valve several times and attempt to close it, and then signal a water valve failure to the user.

### 4.3 Heating Element Failure

This fault can be determined when the controller 22 senses no rise in temperature of the stored water even after instructing the heating element 18 to turn on.

### 4.4 Possible Leak

In this faulty condition, the flow sensor 42 senses no flow of water through the pump 16. Despite this, the controller 22 senses a steady drop in water level in the storage tank. This would indicate that there might be a water leak in the tank itself.

### 4.5 Component Condition

The controller may also be able to track the use of installed components and advise when the components are in need of repair.

For instance, the controller is able to store the temperature of the water in the tank when heating starts, and can measure how long it takes for the water to rise 10° C. for example. Ideally, this feature is enabled from the moment the controller first begins operating so that there is a record of the duration the heating process took during past attempts to heat the water. By using this record, the controller is able to calculate the expected elapsed time to heat the water by 10° C. The controller then compares the actual elapsed period and the expected elapsed period, and is able to make a judgement on the heating element.

If, for example, the actual elapsed period is significantly higher than the expected elapsed period, the controller may deduce that the heating element wire has aged. This is based on the understanding that the aged element may have increased electrical resistance and a reduced effectiveness. Alternatively or additionally, the heating element's thermal resistance may have risen because scale has built up on the heating element. Based on these findings, the controller may issue an indication to the user to the effect that the heating element needs inspection or replacement.

In terms of pump components, the controller can monitor when current is applied to start the pump, and can measure the time in takes for the water pressure to reach the desired level. The time taken may indicate whether the bearings in the pump need replacing, or whether the pump vanes are obstructed.

As mentioned earlier, the controller is able to vary delivery pressure by varying the voltage (and therefore the current) supplied to the pump. If a record of current and/or voltage is stored with reference to the delivery pressure produces, the controller can compare the voltage required to produce a specified pressure today, with the voltage required months or even years ago. In this way, the controller can monitor the pump for signs of reduced performance that may indicate that the pump needs replacement or repair.

Furthermore, the controller may keep a record of how long the tank takes to fill completely and the relevant date the tank was filled. If it takes a longer time to fill the tank today than it did months or years ago, this may indicate that the water inlet is obstructed. In the form where a mesh screen is fitted to the inlet of the solenoid, the controller may infer that the mesh screen is obstructed with rust.

The storage tank used may be that of a flexible liner form, as disclosed in New Zealand Patent No. 244107. In this embodiment, the controller holds data relating to the expected lifetime of the flexible liner. The lifetime of the liner is shortened when the tank is filled with hot water—the hotter the water, the shorter the life expectancy. Since the controller records the water temperature and the levels of water, it can make an informed guess about the liner and its life expectancy, and accordingly warn the user when it decides that the liner is likely to need replacement.

### 5.0 Example Operations

### 5.1 Energy Source Selection

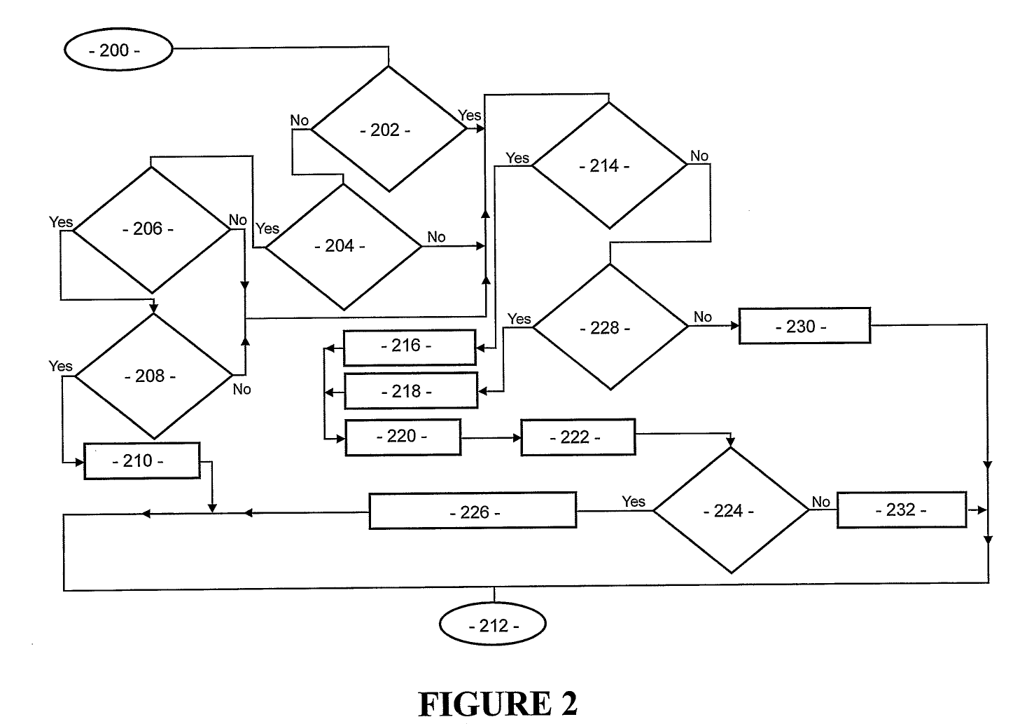

FIG. 2 shows a flow chart of one example controller process for determining which energy source to use to heat water in the storage tank. The process begins at step 200, which is initiated when the system is required to heat the stored water. For example, the user may initiate a heating request using the keypad unit as previously described. Alternatively, the controller may automatically initiate heating in response to a time-trigger, such as those occurring in the ‘Holiday’ or ‘Efficiency’ modes. Heating may also be enabled by the controller, for instance, at the end of a fill cycle which was initiated after the tank contents reached a minimum level (as sensed by the level sensor).

In step 202, the controller determines whether the user has requested the heating of the water. If this determination is in the negative, the controller proceeds to step 204, in which the Real Time Clock (RTC) is checked to determine if the current time corresponds to daylight hours. If so, the controller checks in step 206 if the water storage system has an alternative energy source, such as a solar heater. In one form, this is done by determining if a solar option in the controller is enabled. Assuming the system does have a solar heater, the controller proceeds to step 208 and determines if the temperature of the solar heater is adequate for heating the stored water. If the temperature is adequate, the controller selects the solar heater as the preferred energy source in step 210. As this completes the selection of energy to use, the controller process ends in step 212.

The above process flow has been described with reference to a solar heater as an alternative energy source. The process can of course be easily adapted to suit other alternative sources, such as gas, oil or electricity.

Referring back to step 202, if the controller determines that the user has in fact demanded heating, the controller proceeds to step 214 to check the availability of real-time pricing data. As previously described, this could be done by providing the controller with access to the internet and a server or website that provides real-time energy prices. If this real-time pricing data is available, the controller downloads or retrieves this data in step 216.

If, however, there are no real-time pricing data available, the controller will proceed to step 228 to determine if any stored pricing data are available. The presence of stored pricing data in the controller leads to step 218, where the stored pricing data are retrieved to be used. The absence of stored pricing data leads to step 230, where the controller decides that no determination can be made with regard to energy prices and thus selects a preset or default energy source.

To use the retrieved or stored pricing data, the controller determines the date and time from the RTC in step 220. This is used in association with the pricing data to determine the prices that apply and the times in which they apply. In step 222, the controller determines if there are any user pricing requirements to adhere to. For instance, the user may have set a criterion/command for the controller to always switch to the cheapest possible energy source. Of course more complex commands may be inputted, for example to select the cheapest energy source unless it is from a non-renewable source and the price difference between the cheapest non-renewable energy source and the next cheapest renewable energy source is less than 5¢/kW, in which case the next cheapest renewable energy source will be selected. A plethora of command possibilities are available and can be configured into the controller by skilled persons.

In step 224, the controller will determine if there are any energy sources that meet the user's criteria. If there is such a source, the controller will select that source in step 226. If no suitable sources are available, the controller may set the energy selection to ‘none’ in step 232 and proceed to exit the routine. It is conceivable that a user may program the controller to use a default energy source if no sources meet the criteria set by the user.

In the preferred embodiment, the process of FIG. 2 is run repeatedly. This allows the controller to change sources, if required, in real-time or ‘on-the-fly’.

### 5.2 Diagnostic Operation

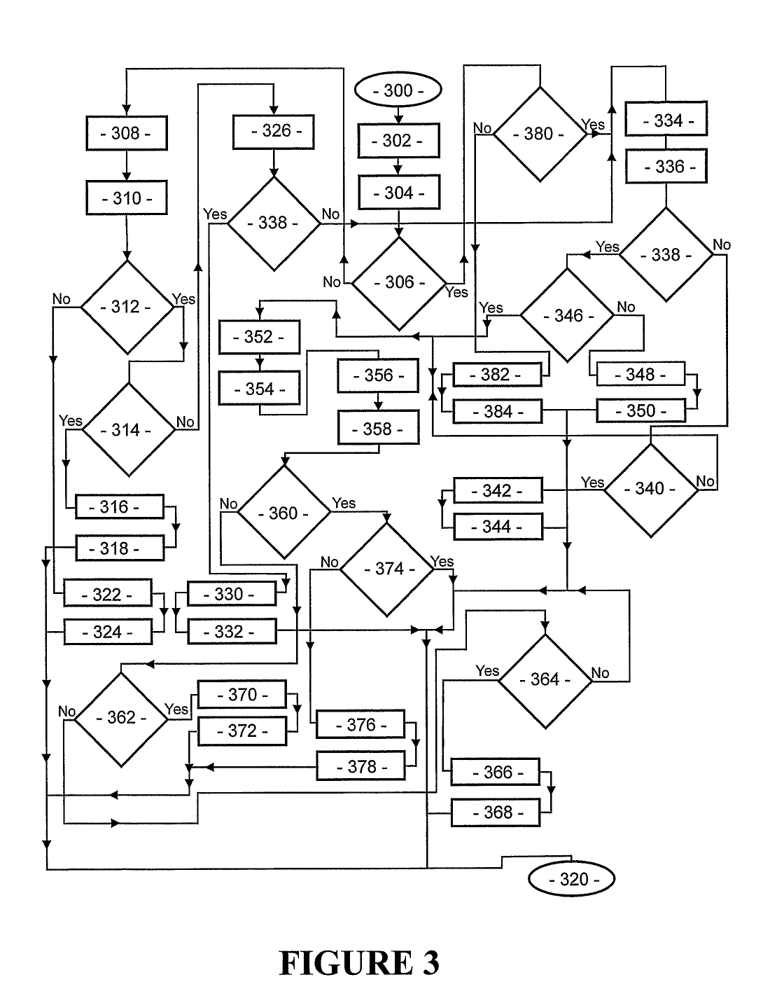

FIG. 3 and the following description provide one example process flow for the diagnostic operation of the controller of the invention. There will be various other ways in which the process flow may be carried out by skilled persons, including making modifications to the example process flow provided.

The diagnostic process begins in step 300. The first process occurs in step 302, where the controller determines the status of the water source solenoid. This is preferably done by checking the status presented on the relevant I/O port of the processor, as mentioned in the description of the controller in section 2.0.

As previously stated, the water source solenoid controls the flow of water from a water source to the storage tank. The status of the valve is preferably limited to two conditions, ‘open’ or ‘close’. Once determined, the status of the solenoid is stored in the data storage device of the controller or in the internal memory of the controller in step 304. A timestamp of when the status was checked is preferably also stored.

In step 306, the controller determines whether the water source solenoid is in an open condition. If the determination yields a negative result, indicating that the solenoid is closed, the controller proceeds to step 308. Otherwise, if the determination yields a positive result, indicating that the solenoid is open, the controller proceeds to step 380. The process flow for each determination will be described separately below.

### 5.2.1 Closed Water Solenoid

### 5.2.1.1 Water Level Diagnostics

If the solenoid is closed, the controller begins the diagnostic in step 308 in which the level sensor of the storage tank is read. In step 310, the level sensor reading is stored in the controller memory or data storage device. Again, a timestamp of when the level sensor was read is preferably also stored.

The controller then determines, in step 312, whether the data from the level sensor is valid. The validity of the sensor data depends on the type of sensor being used—examples of sensor type and data validity were described in section 2.1.3. Provided the data is valid, the controller proceeds to step 314 to determine whether the water level in the storage tank is too high, or overfilled. If the tank is overfilled, the controller shuts down the tank in step 316 and sends a ‘Tank Overfull’ message to the display unit in step 318. In the preferred embodiment, the tank is shut down by the controller turning off all triac switches in the control circuit of the controller. The diagnostic process in this case ends in step 320.

Referring back to the determination in step 312 of whether the data from the level sensor reading was valid, a determination of invalid data will result in the controller shutting down the tank in step 322, and subsequently displaying the message ‘Level Sensing Probe Failure’ in step 324. This diagnostic presumes that invalid data returned from the level sensor is most likely attributable to a failed level sensor. The process then exits in step 320.

Referring back to the determination in step 314 of whether the tank was overfilled, a determination in the negative (i.e. tank is not overfilled) will result in the controller retrieving the stored values of the water level and timestamp in step 326. The controller then determines whether the water level has increased in step 328. This could be done by comparing the current water level against earlier water levels recorded by the controller. If the water level has increased even though the water source solenoid was instructed to turn off (closed state), the solenoid most likely has failed to keep the source water from flowing into the storage tank. Therefore, the controller shuts down the tank in step 330 and displays the message ‘Solenoid Failure’ on the display unit in step 332. The process then exits in step 320.

As for the determination of whether the water level in the storage tank is increasing (step 328), if the controller finds no increase in water level, the water level in the system is found to be normal and the water level diagnostic is completed. This is in line with the expectation that, if the water source solenoid is closed, there should be no increase in stored water levels. The controller then moves on to diagnose the heating features of the system in step 334.

### 5.2.1.2 Water Temperature Diagnostics

In step 334, the controller reads the heating element status, namely whether the element has been switched on or off. The status of the heating element is stored in step 336, preferably together with a timestamp of when the reading was made.

In step 338, the controller retrieves the status of the heating element. Presuming that the heating element is found to be in an ‘off’ state, the controller checks the water temperature in the tank in step 340. If the temperature is increasing, the controller shuts down the tank in step 342 and displays the message ‘Element Triac Failure’ in step 344. The process then ends in step 320.

Presuming that the heating element is found to be in an ‘on’ state, the controller also checks the water temperature in the tank, this time in step 346. If the water temperature is not rising, the controller shuts down the tank in step 348 and displays the message ‘Element Failure’ in step 350. This assumes that the most probable cause of water temperature not rising after the heating element has been instructed to turn on is a failure on part of the heating element.

If the water temperature is found to be rising in step 346 (the case where the heating element is turned on) or if the water temperature is found to be not rising in step 340 (the case where the heating element is turned off), the water temperature diagnostics are found to be normal and is completed. From here, the controller moves on to diagnose the water flow and pressure characteristics of the system.

### 5.2.1.3 Water Flow & Pressure Diagnostics

When the water temperature diagnostics are completed as above, the controller proceeds to step 352 in which the flow sensor status is read. This status together with a timestamp are stored for later reference in step 354. The controller then reads the water pressure sensor in step 356 and stores the status together with a timestamp in step 358.

The process continues in step 360 where the controller determines, from the flow sensor reading, whether the flow switch is in an open or close condition. Assuming that the system is drawing no water and the flow switch is open, the controller then checks whether power is being supplied to the water pump in step 362. If no power is being supplied, the controller then determines, from the pressure sensor, whether the water pressure has increased in step 364. If there is no water pressure increase, the system is assumed to be working in good order.

If, however, there is a water pressure increase, the controller proceeds to shut down the tank in step 366 and display the message ‘Pump Triac Failure’ in step 368. This is because the water pressure is sensed as increasing despite the reading that no power is being supplied to the water pump. The process then exits in step 320.

If there is indication that power is being supplied to the pump in step 362, the controller shuts down the tank in step 370 and displays the diagnostic message ‘Pump Control Software Failure’ in step 372. This is based on the flow switch being open (indicating no flow of water) even after the pump is powered up. It is presumed that the most likely cause of this is the failure of the pump control software to turn the pump off.

Referring back to step 360, where the controller determines whether the flow switch is turned on, and assuming the determination is positive, the controller proceeds to step 374. Here, the controller determines if the water pressure has increased. If this determination is in the negative, the controller shuts down the tank in step 376 and displays the message ‘Pump Failure’ in step 378. This will indicate that the pump has failed to operate to increase the water pressure even after the flow switch is enabled. If, however, the determination is in the positive, the system will be seen to be operating in good order and the process ends in step 320.

### 5.2.2 Open Water Solenoid

As stated above, this situation arises when the determination of the solenoid status in step 306 reveals that the water source solenoid is open. The process here begins in step 380, where the controller determines whether the water level in the storage tank is increasing. If it is not increasing, the controller shuts down the tank in step 382 and displays the message ‘Fill Failure’ in step 384. This signifies that, even with an open water source solenoid and thus an allowed flow from the source to the tank, there is no water inflow into the storage tank.

If, however, the water level is increasing, the water level diagnostics are found to be normal and are completed. As with the closed water solenoid case, the process then proceeds to examine the heating aspects of the water storage system. The process thus proceeds to step 334, as explained earlier in section 5.2.1.2. Also as with the closed water solenoid case, the completion of the heating aspects diagnostics marks the beginning of the water flow and pressure diagnostics, as described in section 5.2.1.3.

The foregoing describes the invention including preferred forms thereof. Alterations and modifications as will be obvious to those skilled in the art are intended to be incorporated within the scope hereof, as defined by the accompanying claims.

1-66. (canceled)

67. An electronic controller for a water storage system, the water storage system having a storage tank in communication with a main energy source and a main water source, the electronic controller comprising:
at least one sensor to generate a sensor signal representing the level of water or the temperature of water in the storage tank;
an input device for a user to input a command signal into the controller; and
a processor in communication with the at least one sensor and the input device, and adapted to receive the sensor signal and command signal, the processor also being in communication with at least one of the main energy source and main water source, the processor also being adapted to receive source information relating to one or more of (i) the cost of energy or water, (ii) a rating of energy or water efficiency and (iii) restriction(s) on the use of energy or water from the main energy source and main water source,
wherein the processor is adapted to control one or more of the following aspects of the water storage system based on the source information, the sensor signal and the command signal: the use of water from the main water source, the use of energy from the main energy source, the level or temperature of water in the tank, and the use of water from the tank.

68. The electronic controller as claimed in claim 67 wherein the restriction(s) on the use of energy and the restriction(s) on the use of water relate to one or more of time, duration and usage amount restrictions.

69. The electronic controller as claimed in claim 67 wherein the source information is obtained from an energy and/or water meter(s).

70. The electronic controller as claimed in claim 67 wherein the processor is adapted to diagnose the condition of one or mole components in the water storage system based on the source information and at least one of the sensor signal and the command signal.

71. The electronic controller as claimed in claim 67 wherein one or more further sensors are provided to supply the controller with sensor signals representing the condition of the water in the storage tank, the further sensors chosen from the group comprising: pH sensors, conductivity sensors, dissolved oxygen sensors, lime sensors and potability-type sensors.

72. An electronic controller for a water storage system, the water storage system having a storage tank provided with a heating device in communication with a main energy source, the electronic controller comprising:
at least one sensor to generate a temperature signal representing the temperature of water in the tank;
an input device for a user to input a command signal into the controller; and
a processor in communication with the at least one sensor and the input device, and adapted to receive the temperature signal and command signal, the processor also being in communication with the main energy source to receive source information relating to one or more of (i) the cost of energy, (ii) a rating of energy efficiency and (iii) restriction(s) on the use of energy from the main energy source,
wherein the processor is adapted to controllably operate the heating device based on the source information, the temperature signal and the command signal.

73. The electronic controller as claimed in claim 72 wherein the restriction(s) on the use of energy relates to one or more of time, duration and usage amount restrictions.

74. The electronic controller as claimed in claim 72 wherein the source information is obtained from an energy meter.

75. The electronic controller as claimed in claim 72 wherein the processor is adapted to connect the heating device to one or more alternative energy sources.

76. The electronic controller as claimed in claim 75 wherein the processor is adapted to connect the heating device to the one or more alternative energy sources if energy from the main energy source is unavailable.

77. The electronic controller as claimed in claim 75 wherein the processor is adapted to connect the heating device to the one or more alternative energy sources if the temperature signal or command signal is determined by the processor to require an alternative energy source.

78. The electronic controller as claimed in claim 75 wherein the processor is adapted to receive information relating to the one or more alternative energy sources.

79. The electronic controller as claimed in claim 78 wherein the information relating to the one or more alternative energy sources is information relating to one or more of the following: the cost of energy, the availability of energy, a rating of energy efficiency, and restriction(s) on the use of energy from the alternative energy sources.

80. The electronic controller as claimed in claim 79 wherein the controller is adapted to optimise energy efficiency based on a user's command signal to select the most energy efficient source.

81. The electronic controller as claimed in claim 80 wherein the controller is adapted to allow a user to set a condition on the selection of the most energy efficient source such that the most energy efficient source is selected so long as any resulting cost change is below a specific amount.

82. The electronic controller as claimed in claim 80 wherein the controller is adapted to allow a user to set a condition on the selection of the most energy efficient source such that the most energy efficient source is selected based on criteria set regarding the availability and efficiency of the source.

83. The electronic controller as claimed in claim 72 wherein the controller includes a data storage device to store the source information relating to the cost of energy from the energy source(s).

84. The electronic controller as claimed in claim 83 wherein information relating to the cost of energy from the energy source(s) is obtainable from an information source remote from the controller.

85. The electronic controller as claimed in claim 84 wherein the information source is provided on one or more websites or online servers.

86. The electronic controller as claimed in claim 72 wherein the storage tank is in communication with a main water source, and the controller is adapted to receive information relating to one or more of the following: the cost of water, the availability of water, a rating of water efficiency, and restriction(s) on the use of water from the main water source.

87. The electronic controller as claimed in claim 86 wherein the controller is adapted to use the information relating to the cost of water to determine the time(s) at which water can be used for cost efficiency.

88. The electronic controller as claimed in claim 86 wherein the controller is adapted to maintain a record of the use of water and/or energy by the storage tank.

89. The electronic controller as claimed in claim 88 wherein the controller is adapted to use the record to predict future water and/or energy requirements for the storage tank.

90. The electronic controller as claimed in claim 88 wherein the controller is adapted to use the record together with information relating to the cost of energy to determine the most cost-effective energy source.

91. The electronic controller as claimed in claim 72 wherein a communication path between the controller and the source(s) allows the source(s) to control the use of water and/or energy by the water storage system.

92. The electronic controller as claimed in claim 72 wherein the controller is adapted to communicate with other appliances or controllers external to the water storage system.

93. The electronic controller as claimed in claim 92 wherein the electronic controller is adapted to communicate with a home automation system, either to deliver information relating to the water storage or to receive information relating to a user command.

94. The electronic controller as claimed in claim 92 wherein the electronic controller is part of a home automation system.

95. The electronic controller as claimed in claim 92 wherein the communication between the controller and external appliances or controllers is based on wireless communication.

96. The electronic controller as claimed in claim 72 wherein the controller is provided with downstream sensors to measure the water pressure and/or flow and/or temperature downstream of the tank, the controller being adapted to receive as input the user's desired value for the water pressure and/or flow and/or temperature, and to control devices such that the water pressure and/or flow and/or temperature sensed by the sensors substantially match the user's desired values.

97. The electronic controller as claimed in claim 72 wherein the controller is adapted to diagnose the condition of one or more components in the water storage system.

98. The electronic controller as claimed in claim 97 wherein the controller is adapted to store status values reflecting instructions that are sent by the controller to operate the one or more components, and wherein the controller is adapted to compare the status values with the measurements of the at least one sensor or the downstream sensors to diagnose the condition of the one or more components.

99. The electronic controller as claimed in claim 97 wherein the controller is adapted to compare the information relating to the water source(s) or the information relating to the energy source(s) with the measurements of the at least one sensor or the downstream sensors to diagnose the condition of the one or more components.

100. An electronic controller for a water storage system, the water storage system having a storage tank connected to a main water source remote from the tank, the electronic controller comprising:
at least one sensor to generate a level signal representing the level of water in the storage tank;
an input device for a user to input a command signal into the controller; and
a processor in communication with the at least one sensor and the input device, and adapted to receive the level signal and command signal, the processor also being in communication with the main water source to receive source information relating to one or more of (i) the cost of water, (ii) a rating of water efficiency and (iii) restriction(s) on the use of water from the main water source,
wherein the processor is adapted to control the level of water in the storage tank based on the source information, the level signal and command signal.

101. The electronic controller as claimed in claim 100 wherein the restriction(s) on the use of water relates to one or more of time, duration and usage amount restrictions.

102. The electronic controller as claimed in claim 100 wherein the source information is obtained from a water meter.

103. The electronic controller as claimed in claim 100 wherein the processor is adapted to connect the storage tank to one or more alternative water sources.

104. The electronic controller as claimed in claim 103 wherein the processor is adapted to connect the storage tank to the one or more alternative water sources if water from the main water source is unavailable.

105. The electronic controller as claimed in claim 103 wherein the processor is adapted to connect the storage tank to the one or more alternative water sources if the level signal or command signal is determined by the processor to require an alternative water source.

106. The electronic controller as claimed in claim 103 wherein the processor is adapted to receive information relating to the one or more alternative water sources.

107. The electronic controller as claimed in claim 106 wherein the information relating to the one or more alternative water sources is information relating to one or more of the following: the cost of water, the availability of water, a rating of water efficiency, and restriction(s) on the use of water from the alternative water sources.

108. The electronic controller as claimed in claim 100 wherein the controller includes a data storage device to store information relating to the cost of water from the water source(s).

109. The electronic controller as claimed in claim 108 wherein information relating to the cost of water from the water source(s) is obtainable from an information source remote from the controller.

110. The electronic controller as claimed in claim 109 wherein the information source is provided on one or more websites or online servers.

111. The electronic controller as claimed in claim 100 wherein the controller is adapted to calculate the volume of water in the tank based on a known tank volume and the level signal.

112. The electronic controller as claimed in claim 111 wherein the storage tank includes a heating device that is connected to a main energy source to heat the water in the tank, and the controller is adapted to estimate the duration in which the water will be heated to a desired temperature.

113. The electronic controller as claimed in claim 112 wherein, based on a user's specification for the water to be heated to a certain temperature as soon as possible, the controller is adapted to either feed the heating device the maximum amount of energy allowable to heat the water or reduce the amount of water in the storage tank so that only the amount of water that is required is heated.

114. The electronic controller as claimed in claim 112 wherein, based on a user's specification for energy efficiency, the controller is adapted to evaluate an ideal time to add unheated water into the tank to prevent an overall decrease in the temperature of the water in the tank when unheated water is added.

115. The electronic controller as claimed in claim 111 wherein the controller is adapted to maintain a record of water usage from the tank, and to estimate the duration of use remaining before stored water runs out.

116. A computer-implemented method of controlling a water storage system, the water storage system having a storage tank provided with a heating device in communication with a main energy source remote from the tank, the method comprising the steps of:
sensing the water temperature in the tank;
receiving a user command from an input device;
receiving source information relating to one or more of (i) the cost of energy, (ii) a rating of energy efficiency and (iii) restriction(s) on the use of energy from the main energy source; and
controlling the heating device in the tank based on the source information, the water temperature and the user command.

117. The computer-implemented method as claimed in claim 116 comprising the further step of connecting the storage tank to one or more alternative energy sources if energy from the main energy source is unavailable.

118. The computer-implemented method as claimed in claim 117 comprising the further step of receiving information relating to one or more alternative energy sources.

119. The computer-implemented method as claimed in claim 118 wherein the step of receiving information relating to the one or more alternative energy sources comprises receiving information relating to one or more of the following: the cost of energy, the availability of energy, a rating of energy efficiency and restriction(s) on the use of energy from the one or more alternative energy sources.

120. The computer-implemented method as claimed in claim 116 comprising the further steps of: determining if an alternative energy source is required, and connecting the storage tank to an alternative energy source if it is determined that an alternative energy source is required.

121. A computer-implemented method of controlling a water storage system, the water storage system having a storage tank connected to a main water source remote from the tank, the method comprising the steps of:
sensing the water level in the tank;
receiving a user command from an input device;
receiving source information relating to one or more of (i) the cost of water, (ii) a rating of water efficiency and (iii) restriction(s) on the use of water from the main water source; and
controlling the level of water in the tank based on the source information, the water level and the user command.

122. The computer-implemented method as claimed in claim 121 comprising the further step of connecting the storage tank to one or more alternative water sources if water from the main water source is unavailable.

123. The computer-implemented method as claimed in claim 122 comprising the further of receiving information relating to one or more alternative water sources.

124. The computer-implemented method as claimed in claim 123 wherein the step of receiving information relating to the one or more alternative water sources comprises receiving information relating to one or more of the following: the cost of water, the availability of water, a rating of water efficiency and restriction(s) on the use of water from the one or more alternative water sources.

125. The computer-implemented method as claimed in claim 121 comprising the further steps of: determining if an alternative water source is required, and connecting the storage tank to an alternative water source if it is determined that an alternative water source is required.
